(19) United States
(12) Patent Application Publication
(10) Pub. No.: US 2010/0021736 A1
(43) Pub. Date: Jan. 28, 2010

(54) INTERFACE-INFUSED NANOTUBE INTERCONNECT

(76) Inventors: Keith A. Slinker, Keller, TX (US); Vasiliki Z. Poenitzsch, Alamo Heights, TX (US)

Correspondence Address: BRACEWELL & GIULIANI LLP, P.O. BOX 61389, HOUSTON, TX, 77208-1389, US

(21) Appl. No.: 12/180,106

(22) Filed: Jul. 25, 2008

(51) Int. Cl. B32B 9/00; B05D 1/36

(52) U.S. Cl. 428/408; 427/203

(57) ABSTRACT

The invention relates to carbon nanotube arrays and methods for the preparation of carbon nanotube arrays. The carbon nanotube arrays include an aligned carbon nanotube array, wherein at least one of the ends of the carbon nanotube array includes a coating layer that is infused into the carbon nanotube array.

### FIELD OF THE INVENTION

The present invention relates to a method of fabricating arrays and devices that incorporate carbon nanotubes.

### BACKGROUND OF THE INVENTION

Carbon nanotubes (CNTs) have gained much interest due to the very unique and desirable properties exhibited by the materials and by devices that are prepared with CNTs. Carbon nanotubes are very small tube-shaped structures each having the structure of a graphite sheet rolled into a tube. Carbon nanotubes exhibit excellent mechanical properties, such as for example, a high Young's modulus, a high elastic modulus, and low density. In addition, CNTs also demonstrate excellent electrical, thermal, electromechanical and absorption properties. Carbon nanotubes display electronic metallic properties or semiconductor properties according to different ways in which the graphite sheet is rolled. Due to these and other properties, it has been suggested that carbon nanotubes may play an important role in a variety of different fields, such as for example, microscopic electronics, materials science, biology and chemistry. One particular use that has been suggested is as a field emission cathodes for the replacement of thermionic cathodes used in microwave tubes.

Carbon nanotubes are also highly desirable due to their ability to form self-assembling linear, forest-like arrays. CNT arrays have been shown to have high thermal and electrical conductivity, extremely low optical reflectivity, excellent emission properties, and to be compliant yet strong. Thus they have been suggested for applications such as field emission devices, conformable electrical interconnects, and mechanically resilient thermal interconnects. However, these CNT arrays generally show poor adhesion and poor conductivity to the substrates they are synthesized on as well as low self-integrity, thereby limiting their potential for use in forming matrices and the fabrication of microelectronic and other devices.

### SUMMARY

In one aspect, a method is provided for the preparation of vertically aligned carbon nanotube arrays that incorporate a coating on at least one end of the array. A substrate suitable for supporting the growth of carbon nanotubes is provided and a plurality of carbon nanotubes are synthesized on a surface of the substrate. The carbon nanotubes include a first end and a second end, wherein the first end is attached to the substrate and wherein said plurality of carbon nanotubes forms a forest of substantially vertically aligned nanotubes. A coating is then deposited on the second end of the carbon nanotubes.

In certain embodiments, the method further includes the steps of removing the substrate from the first end of the carbon nanotubes and depositing a second coating on the first end of the carbon nanotubes. The coating layer can be selected from a variety of materials, including metal, composites, alloys, and polymers.

In another aspect, a carbon nanotube array is provided that incorporates a coating on at least one end of the carbon nanotube array, wherein the coating is partially infused into the carbon nanotube array.

### BRIEF DESCRIPTION OF THE DRAWINGS

FIG. 1 is a schematic of the process for the preparation of carbon nanotube arrays according to one embodiment of the present invention.

FIG. 2 is a scanning electron micrograph of a carbon nanotube array.

FIG. 3 is a carbon nanotube device according to one embodiment of the present invention.

FIG. 4 is a carbon nanotube device according to another embodiment of the present invention.

FIG. 5 is a carbon nanotube device according to another embodiment of the present invention.

FIG. 7 is a carbon nanotube device according to another embodiment of the present invention.

FIG. 8 is a carbon nanotube device according to another embodiment of the present invention.

FIG. 6 is a carbon nanotube device according to another embodiment of the present invention.

FIG. 9 is a scanning electron micrograph of various coating layers on a CNT array according to one embodiment of the present invention.

FIG. 10 is a scanning electron micrograph of a CNT device according to the present invention.

### DETAILED DESCRIPTION OF THE INVENTION

Although the following detailed description contains many specific details for purposes of illustration, one of ordinary skill in the art will appreciate that many variations and alterations to the following details are within the scope of the invention. Accordingly, the exemplary embodiments of the invention described below are set forth without any loss of generality to, and without imposing limitations thereon, the claimed invention.

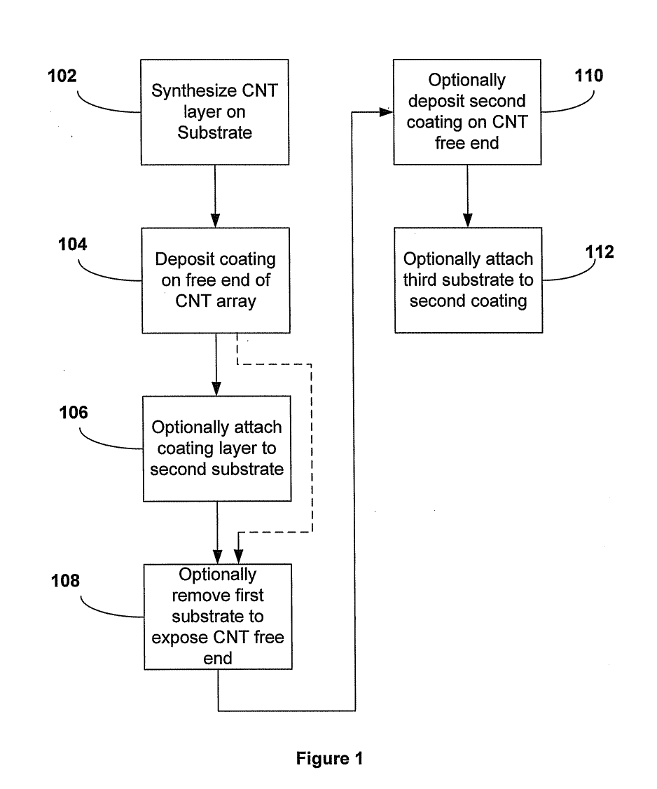

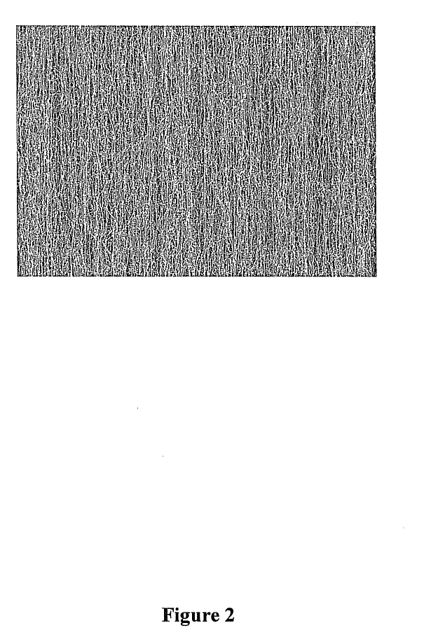

In one aspect, a method is provided for the preparation of a CNT array that includes a coating on at least one end of the array. The process for preparing arrays according to one embodiment of the present invention is shown in the schematic in FIG. 1. In a first step 102, a substantially vertically aligned CNT layer is deposited on the surface of a substrate. An exemplary scanning electron micrograph of a CNT array is shown in FIG. 2. In a second step 104, a coating is applied to the exposed end of the CNT layer. The coating can be metal, diamond-like carbon (DLC), polymer, silicon carbide or the like and becomes partially imbedded or infused into the CNT layer. In an optional third step 106, the coating layer is attached to a second substrate. In an optional fourth step 108, following step 104 or 106, the first substrate can be removed to expose a free end of the CNT layer. In an optional fifth step 110, a second coating layer can be deposited on the newly exposed free end of the CNT layer in a manner similar to the deposition of the first layer. In an optional sixth step 112, the second coating layer can be attached to a third substrate. As provided the first and second coating layers can be the same, or they can be different. Similarly, the first, second and third substrates can be the same or they can be different.

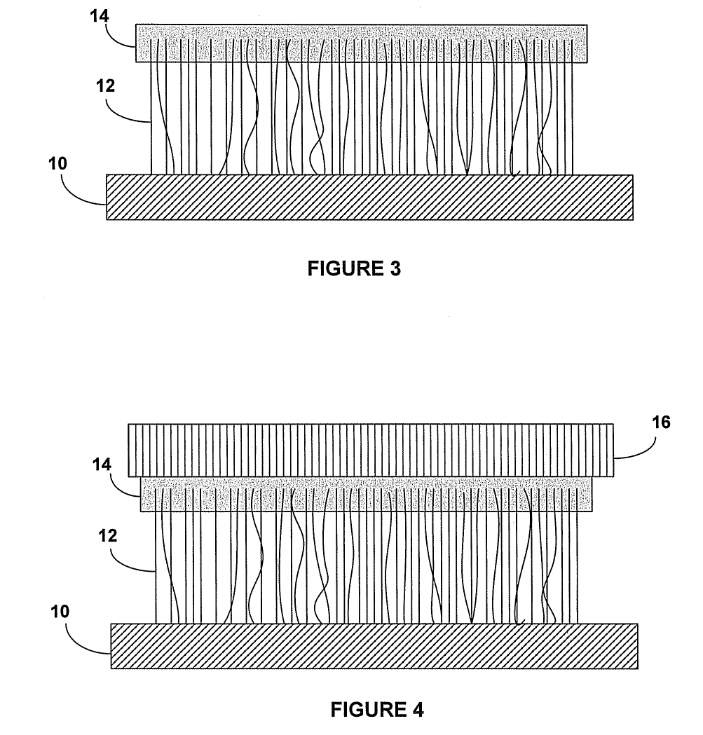

In one embodiment, as shown in FIG. 3, the CNT array can include a substrate material 10, a substantially vertically aligned CNT layer 12 and a coating 14 that partially infuses into the CNT layer to provide a cap to the free end of the CNT layer distal from the substrate surface. The CNT layer 14 is attached to the substrate 12 at a first end, and the coating 16 is applied to a second end of the CNT layer.

The substrate 10 material can be a variety of known material suitable for the growth of CNTs. One exemplary substrate material is silicon dioxide (or a silicon substrate that has been oxidized), which provides the advantage of having a surface from which the CNT layer may be easily removed.

The carbon nanotubes 12 can be applied to the substrate 10 by known means, including but not limited to, chemical vapor deposition (CVD) synthesis or plasma enhanced chemical vapor deposition (PECVD), such as the Black Magic process (Slade Gardner, et al.). The chemical vapor deposition method is known in the art as being conducive to growing CNT arrays with the nanotubes that are substantially aligned and form a forest-like growth that is oriented substantially vertical to the surface of the substrate. In the chemical vapor deposition method, a carbon source gas is thermally decomposed at a predetermined temperature in the presence of a transition metal that acts as a catalyst, thereby forming a carbon nanotube array. In certain embodiments, the substrate may be prepared or conditioned by known means prior to the deposition of the CNTs to promote the growth and/or attachment on the surface thereof. In certain embodiments, the carbon nanotubes deposit in a manner such that the nanotubes only occupy about 10% of the total volume. In certain other embodiments, the carbon nanotubes occupy between about 10% of the total volume and about 20% of the total volume. In certain embodiments, with post processing techniques, the CNTs can occupy greater than about 50% of the total volume, greater than 75% of the volume, and in certain embodiments, greater than 90% of the total volume.

In certain embodiments, the CNT layer can be between about 1 micron and several centimeters in length. In certain other embodiments, the CNT layer can be between about 1 micron and 100 microns. In certain embodiments, the CNT layer can be between about 2 microns and 20 microns. It is understood that as the technology advances, CNT arrays of lengths longer than several centimeters will be possible.

The coating or cap layer 14 can be a metal, ceramic, composite, alloy, or polymer material that partially infuses into the CNT layer. The coating or cap layer 14 can be applied to the free ends of the CNT layer 12 by a variety of means. In certain embodiments, the material can be applied by vapor phase deposition, including, for example, chemical vapor deposition (CVD) PECVD, or physical vapor deposition. A variety of materials can be applied to the carbon nanotubes by these techniques, particularly metals, such as for example, but not limited to, titanium, aluminum, molybdenum, tungsten, tantalum, nickel, gold, silver, copper, and the like. In certain embodiments, alloys and compounds typically used in the microelectronics industry, including but not limited to, silicon dioxide, silicon-germanium, silicon nitride, silicon oxynitride and titanium nitride, can be applied by vapor phase deposition. In certain embodiments, diamond-like carbon or diamond-like nanocomposite coatings (such as for example, composites that include carbon, hydrogen, silicon and oxygen) can be applied to the ends of the carbon nanotubes by known methods. In certain other embodiments, the metals can be deposited on the surface by magnetron sputter deposition. The process conditions for the vapor phase deposition, such as temperature and power, can be varied to change or modify the resulting coating.

In certain embodiments, silicon carbide can be deposited on the surface of the CNT array by CVD techniques. Alternatively, a poly(methylsilyne) can be applied to the CNT surface as a solution and pyrolyzed to achieve the silicon carbide coating.

In certain embodiments, the coating can be applied to the exposed carbon nanotube end by depositing the material as a liquid. Materials suitable for liquid deposition include, but are not limited to, aluminum, solder (e.g., Pb—Sn), and silicon carbide precursors, in addition to a variety of organic and organometallic polymers. Penetration of the liquid can be controlled by a variety of means, including but not limited to, the amount of time the surface is exposed to the liquid, the viscosity of the liquid, the hydrophobicity of the liquid and the conditions under which the liquid is applied to the CNT layer (i.e., the layer is heated, the liquid is heated, etc). In certain embodiments wherein a polymer is used to infuse the carbon nanotube array, the array may undergo a cure of post deposition process, depending on the polymer used.

The coating infuses or imbeds itself into the carbon nanotube array. In certain embodiments, the coating infuses between about 1 and 3 microns into the carbon nanotube array. In other embodiments, the coating infuses between 2 and 6 microns. In yet other embodiments, the coating can infuse the carbon nanotubes by up to 10 microns. In yet other embodiments, the coating can penetrate further into the array, up to and including the entire carbon nanotube array to the substrate.

The coating material can be selected based upon the desired properties and end application. In certain embodiments, the coating material, whether applied by vapor phase or liquid deposition, is selected such that the coefficient of thermal expansion (CTE) closely matches that of the substrate to which it is to be attached. Alternatively, in another embodiment, the coating material is selected such that the CTE of the coating material closely matches that of the CNT layer. In yet another embodiment, the coating material is selected to achieve maximum thermal conductivity. In yet another embodiment, the coating material is selected for maximum mechanical stability. In yet another embodiment, the coating material is selected to achieve maximum electrical conductivity. In yet another embodiment, the coating material is selected for its optical behavior. In yet another embodiment, the coating material is selected to maximize adhesion to the substrate to which is will be attached. In yet another embodiment, the coating material can include more than one material. In embodiments wherein the CNT array is positioned between two coating layers, the coatings can be the same, or in alternate embodiments, the coatings can be different.

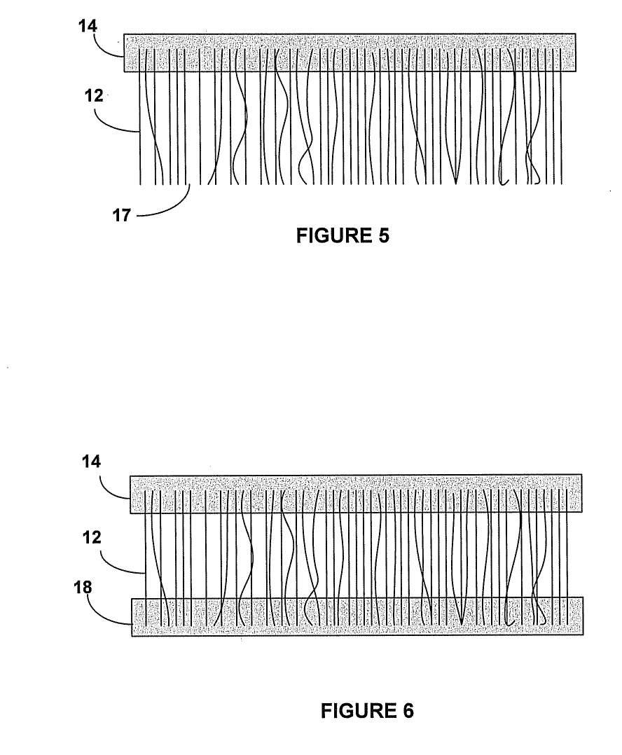

In another embodiment, the coating layer on the CNT array can provide additional means from which to manipulate the CNT array. The metal layer provides mechanical strength and electrical conductivity to the system. In certain embodiments, the metal layer can be attached to a second substrate material, as shown for example, in FIG. 4, wherein the metal coating 14 is attached or adhered to a second substrate 16. Exemplary materials to adhere the metal coating 14 to a second substrate 16 include known adhesives (including but not limited to pressure adhesives and tapes), epoxies and other heat or chemically activated adhesives and solders, as is known in the art. Preferably, the means for attaching the second substrate are selected based upon the end use of the array.

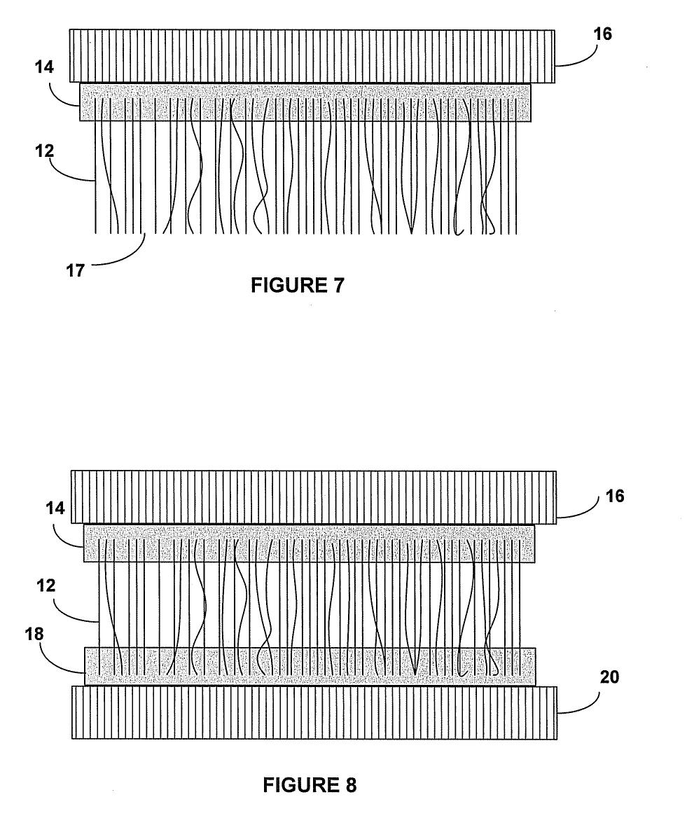

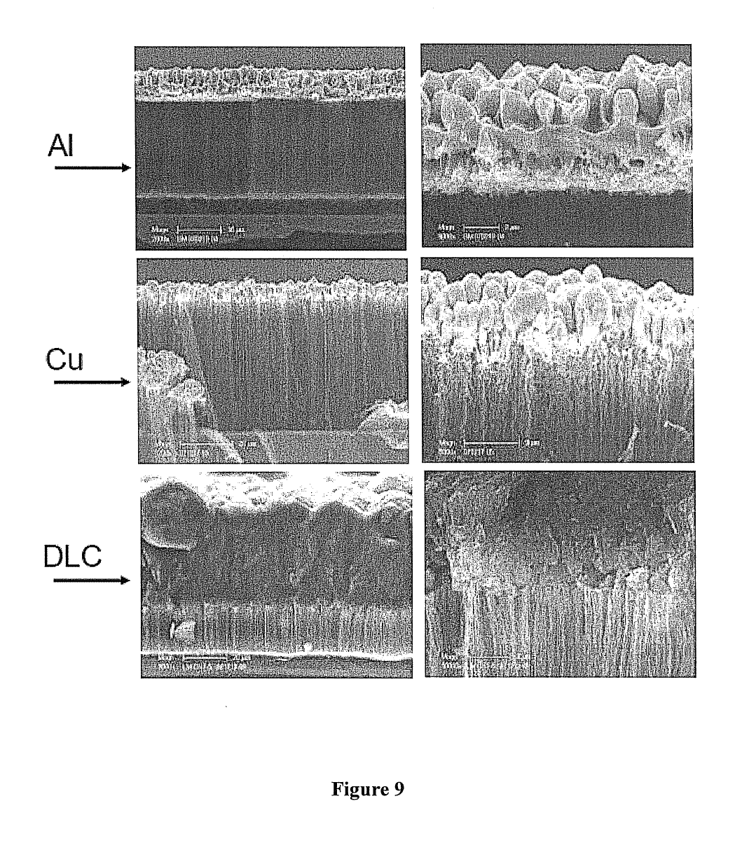

In certain embodiments, as shown in FIGS. 5 and 7, the initial substrate 10 can be removed from the array to expose the first end 17 of the CNT layer 12, thereby allowing the CNT layer to be manipulated. The coated CNT layered structure can typically be easily removed from the substrate on which the CNTs are initially grown. Generally, the adhesion of the CNT layer to the substrate is poor, thereby facilitating removal. In certain embodiments, only a small amount of effort may be all that is required to peel off the coated CNT layer from the substrate. As noted previously, in certain embodiments, the CNT array can be prepared on a silicon substrate, which thereby facilitates the removal of the carbon nanotubes from the substrate surface. In certain embodiments, heat may be applied to the CNT array to facilitate the removal of the array from the substrate. In certain embodiments, the CNT array may be heated to about 500° C. in air to promote removal of the CNT and coating layer from the growth substrate. In certain other embodiments, a chemical release agent can be applied to the CNT and coating layer to facilitate removal of the carbon nanotube array from the substrate.

As shown in FIG. 6, a second coating layer 18 can be applied to the newly exposed CNT layer 17 according to the deposition means previously described. The second coating 18 can be the same material as was applied as the first coating 14, or it can be a different material. The resulting structure can have a sandwich-like structure (e.g. metal-CNT layer-metal or metal-CNT layer-ceramic).

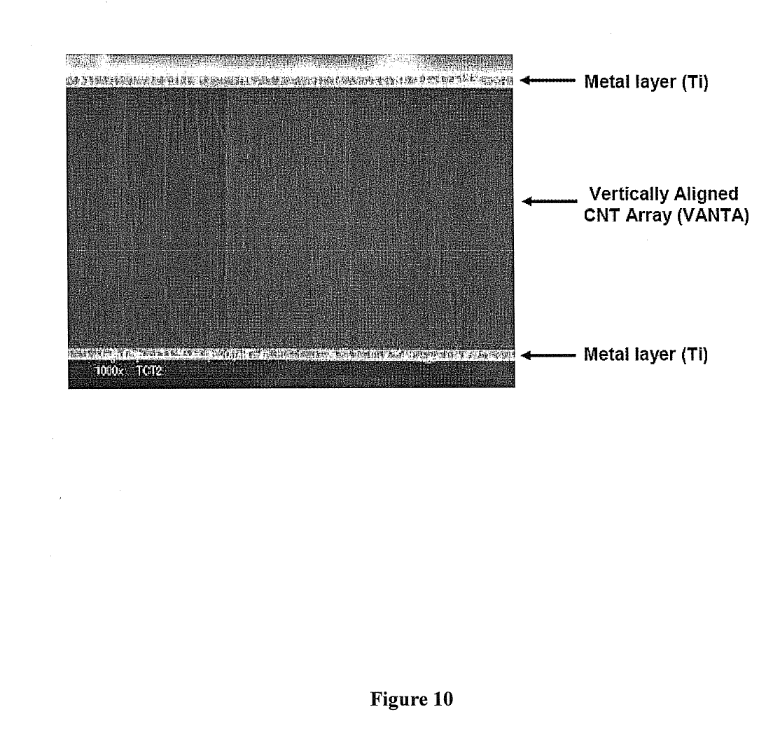

As shown in FIG. 8, the second coating 18 can be attached or adhered to a third substrate 20 by the means previously described with respect to the attachment of second substrate 16 to the first coating layer 14.

FIG. 9 shows a scanning electron micrograph from a scanning electron microscope (SEM) of an exemplary CNT array wherein a vertically aligned CNT array is positioned between titanium coatings. FIG. 10 shows scanning electron micrographs for the deposition of aluminum, copper and diamond-like carbon (DLC) onto one surface of a CNT array.

In certain embodiments, one or both of the surfaces of the CNT layer can be modified by chemical or physical means prior to the deposition of the coating layer. In certain embodiments, the surface of the CNT layer can be exposed to a plasma source prior to deposition of the coating layer.

Characterization of the coated structure demonstrates that the CNTs of the coated CNT arrays are not affected by the coating process as Raman spectroscopy reveals that the materials are the same, before and after the application of the coating layer.

In certain embodiments, the tensile strength of the metal-CNT layer interface is at least about 5 MPa. In certain other embodiments, the tensile strength is at least about 7 MPa. In yet other embodiments, the tensile strength is at least about 8 MPa. In yet other embodiments, the tensile strength is greater than at least about 10 MPa.

Individual single carbon nanotubes have high tensile strength and high thermal conductivity along their axis. The typical CNT array is characterized in that it is compressible such that it is both structurally and mechanically similar to an open-celled foam structure. The typical CNT arrays prepared according to the methods provided herein have a conductivity of at least about 10 W/mK, preferably at least about 15 W/mK.

In certain embodiments, a thick coating can be applied to the CNT array to provide a system that is self supporting. In certain embodiments wherein coating is a metal layer about 5 microns thick. In certain other embodiments, the metal coating layer can be about 4 microns thick. In yet other embodiments, the metal layer is between about 4 and 7 microns thick. As is understood in the art, the thickness of the coating layer required for the array to be self supporting varies based upon the particular coating material and the parameters under which it is deposited.

Infusion of the coating into the top region or top few microns of the carbon nanotube array can lead to improved adhesion and higher conductivity of the coating to the carbon nanotube array as compared with a coating that is not infused into the CNT array. By limiting the infusion of the coating to the top region or top few microns of the CNT array, the bulk properties of the carbon nanotube array, such as for example, compliancy, can be preserved. The amount of infusion can be controlled through choice of such parameters as coating material, method of deposition, and deposition parameters.

Controlling the coating thickness and the amount of infusion of the coating into the CNT array are aspects of the invention which allows for the manipulation of the coated CNT arrays, and may have additional applications outside of the primary focus of this disclosure. For example, the CNT array has been characterized elsewhere to have excellent optical absorbance (e.g. it is very black). The coated CNT array can be applied to an object such that the foil side is applied or adhered to the surface of the object, such that the uncoated side of the CNT array were exposed, thereby providing an alternative to painting an object black.

The CNT array can also be used as a thermal interconnect, wherein a first object can be attached to the coated face of the CNT array (e.g. by soldering or with epoxy or any other known adhesive) and the second object can be attached or adhered to the opposite face of the CNT array (Figure F). In this device, there is no mechanical connection between the CNT array and the surface of the second object, however the thermal conductivity though the CNT array would still be high. Thermal conduction may be decreased if the system experiences mechanical stress.

Exemplary devices that can be prepared from the carbon nanotube devices described herein include devices suitable for the removal of heat from an electronic device. The carbon nanotube array can be connected to a cold plate or thermal spreader at one end, thereby facilitating the transfer of heat through the carbon nanotube array.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these reference contradict the statements made herein.

That which is claimed is:

1. A method a forming a carbon nanotube array, comprising:
providing a substrate suitable for supporting the growth of a plurality of carbon nanotubes;
depositing a plurality of carbon nanotubes on a surface of the substrate, said carbon nanotubes having a first end and a second end, wherein the first end is attached to the substrate and wherein said plurality of carbon nanotubes forms a forest of substantially aligned nanotubes;
depositing a first coating on the second end of the carbon nanotubes.

2. The method of claim 1 further comprising the steps of:
removing the substrate from the first end of the carbon nanotubes; and
depositing a second coating on the first end of the carbon nanotubes.

3. The method of claim 2 wherein the first and second coating are the same material.

4. The method of claim 2 wherein the first and second coating are different materials.

5. The method of claim 2 wherein the first and second coating are independently selected from titanium, aluminum, gold, silver, copper, solder, diamond-like carbon, or a silicon carbide precursor.

6. The method of claim 1 wherein the first coating is selected from titanium, aluminum, gold, silver, copper, solder, diamond-like carbon, or a silicon carbide precursor.

7. The method of claim 1 wherein the carbon nanotube forest has a length of between 10 microns and 2 mm.

8. The method of claim 1 wherein the carbon nanotube forest has a density of approximately 10%.

9. A carbon nanotube array, comprising
a plurality of vertically aligned carbon nanotubes, said nanotubes having a first and a second end; and
a first metal layer coupled to the first end of the plurality vertically aligned carbon nanotubes, wherein the first metal layer partially infuses the plurality of vertically aligned carbon nanotubes.

10. The carbon nanotube array of claim 10 further comprising a second layer coupled to second end of the plurality of vertically aligned carbon nanotubes, said second layer partially infusing the plurality of vertically aligned carbon nanotubes.

11. The carbon nanotube array of claim 11 wherein the second layer selected from a polymer, silicon carbide or nanocomposite.

12. The carbon nanotube array of claim 10 wherein the metal infuses into the first end of the plurality of vertically aligned carbon nanotubes by at least 2 microns.

13. The carbon nanotube array of claim 11 wherein the metal infuses into the first end of the plurality of vertically aligned carbon nanotubes by at least 2 microns and the second coating infuses into the second end of the plurality of vertically aligned carbon nanotubes by at least 2 microns.

14. A carbon nanotube array, comprising
a plurality of vertically aligned carbon nanotubes, said nanotubes having a first and a second end; and
an end cap layer coupled to the first end of the plurality vertically aligned carbon nanotubes, wherein the end cap layer partially infuses the plurality of vertically aligned carbon nanotubes.

15. The carbon nanotube array of claim 14 wherein the end cap lay comprises silicon carbide.

16. The carbon nanotube array of claim 14 wherein the end cap layer comprises a polymer.
